(19) United States
(12) Patent Application Publication
(10) Pub. No.: US 2022/0122195 A1
(43) Pub. Date: Apr. 21, 2022

(54) METHOD, SYSTEM, AND MEDIUM FOR SOCIAL MEDIA CONTENT MONITORING

(71) Applicant: PF IP Holdings Inc., Oakville (CA)

(72) Inventors: Abdulmajid ALAMEDDINE, Oakville (CA); Roger R. FOISY, Brampton (CA)

(21) Appl. No.: 17/482,207

(22) Filed: Sep. 22, 2021

Related U.S. Application Data
(60) Provisional application No. 63/093,027, filed on Oct. 16, 2020.

(30) Foreign Application Priority Data
May 14, 2021 (CA) 3118399

(51) Int. Cl. G06Q 50/00; H04L 29/08; G06F 21/31; G06Q 20/12

(52) U.S. Cl. CPC G06Q 50/01; G06Q 20/12; G06F 21/31; H04L 67/306

(57) ABSTRACT

A method, system, and processor readable medium for ongoing monitoring, collection, organization, storage, and processing of online content from a plurality of online social media accounts controlled by a single user. A social media monitoring system acts as a middleman between a social media user and an investigatory organization to facilitate the collection of social media account credentials from the social media user, use these credentials to monitor and collect the social media user's social media content on an ongoing basis, and grant various levels of access to the content to one or more members of the investigative organization to perform various investigatory tasks. Reports may be generated and provided to the investigative organization based on the social media user's aggregated social media content across multiple accounts, including reports that summarize the subject's activity before and after a specified event, such as an injury or other trauma giving rise to a lawsuit.

### RELATED APPLICATIONS

This applications claims priority to U.S. Provisional Patent Application No. 63/093,027, filed Oct. 16, 2020, and to Canadian Patent Application No. 3,118,399, filed May 14, 2021, each of which is incorporated by reference herein in its entirety.

### TECHNICAL FIELD

The present disclosure relates to methods for monitoring online content, and in particular, to methods and systems for ongoing monitoring, collection, storage, and processing of online content from a plurality of online accounts controlled by a single user.

### BACKGROUND

Online social media may provide substantial insight into an individual user's life. Accordingly, gaining access to social media content has become a high priority for investigators, litigants, potential employers, and others who may have an interest in learning the details of a user's personal life.

However, monitoring a user's activities over time using social media presents several challenges. First, much of the content of a user's social media accounts is only accessible to the user's existing personal contacts, or sometimes only the user him- or herself. Second, the content often exists in multiple formats controlled by multiple social media platform providers, preventing the content from being easily organized and analyzed. Third, it is exceeding difficult to monitor the social media accounts of many users on multiple platforms, requiring a significant investment in human resources.

Existing approaches to social media content monitoring generally fall into two categories, authorized or unauthorized. Unauthorized approaches are typically limited to the subset of a user's social media content that is accessible by the general public. Authorized approaches rely on the entity performing the investigation having unrestricted access to the user's social media accounts. This typically requires that the investigator and social media user have a pre-existing trusted relationship, as the user may need to trust the investigator not to delete or alter his or her social media content once given access. It also typically requires that the investigator obtain social media account credentials directly from the user in order to gain access to the user's accounts, thereby obligating the investigator to maintain the security of those credentials. Finally, these existing approaches typically involve a single archive of social media content maintained and accessed by a single investigator, limiting the ability of organizations to task different members of the organization with different roles involving different types of interaction with the archived content.

Thus, there exists a need for an approach to social media content monitoring, organization, and reporting that overcomes one or more of the aforementioned disadvantages.

### SUMMARY

The present disclosure provides a method, system, and processor readable medium for ongoing monitoring, collection, organization, and processing of online content from a plurality of online social media accounts controlled by a single user. Example embodiments described herein may act as an intermediary between a subject (i.e. the social media account user) and an advocacy or investigatory organization (e.g., a potential employer, or a law firm client) to facilitate the permission-based collection of social media account credentials from the subject, use these credentials to monitor and collect the subject's social media content on an ongoing basis, and grant various levels of access to the content to one or more users (e.g., members of the investigative organization) to perform various advocacy or investigatory tasks. Reports may be generated and provided to users based on a subject's aggregated social media content across multiple accounts, including reports that summarize the subject's activity before and after a specified event, such as an injury or other trauma giving rise to a lawsuit.

The present disclosure may exhibit one or several advantages over existing techniques described above. By managing the interaction with the subject, the present system may relieve the investigatory organization of the need to interview the subject, handle the subject's social media account login credentials (e.g., obtain them, use them, and safeguard them), or process any intake fees from the subject. By providing varying access levels to different roles within the investigatory organization, the present system may enable users in multiple user roles (e.g., reviewer, investigator, clerk, junior attorney, senior attorney) to perform the tasks necessary to that role but prohibit other actions that could result in the loss, corruption, or improper disclosure of the subject's data and/or medata relating thereto generated by the investigatory organization. The present system may be provided as an online service using a network server or cloud computing platform, thereby enabling interaction with subjects and users located in multiple locations and facilitating the ongoing monitoring of social media accounts for multiple subjects.

In accordance with a first aspect of the present disclosure, there is provided a method for monitoring online social media content, comprising a number of steps. Social media account credentials for a plurality of social media accounts controlled by a subject are received at a social media monitoring system. Each social media account corresponds to an online social media service. For each social media account, the credentials for the social media account are transmitted from the social media monitoring system to a social media server for the online social media service to obtain access to the social media account. For each social media account, social media content is retrieved from the social media server to the social media monitoring system. The social media monitoring system stores the social media content in association with a subject identifier.

In some example, the method further comprises receiving, at the social media monitoring system, subject contact information from a first user, and using the subject contact information to send a communication from the social media monitoring system to the subject prompting the subject to provide the social media account credentials to the social media monitoring system. The social media account credentials are received from the subject.

In some examples, the communication further prompts the subject to authorize a payment, and the subject is prompted to provide the social media account credentials in response to determining that the user has authorized the payment.

In some examples, the method further comprises, after storing the content, sending a communication to a second user notifying the second user of the storage of the subject's social media content.

In some examples, the method further comprises providing access to the stored social media content to the second user.

In some examples, the method further comprises, after storing the social media content, monitoring the plurality of social media accounts for changes to the social media content, and, in response to detecting a change to the social media content, retrieving changed social media content from the social media server and storing the changed social media content in association with the subject identifier and a time identifier.

In some examples, retrieving changed social media content from the social media server comprises scheduling said retrieval to keep a simultaneous number of retrieval requests to the social media server below a predetermined threshold.

In some examples, the method further comprises determining that the social media account credentials for a first social media account of the social media accounts are no longer valid, sending a second communication from the social media monitoring system to the subject prompting the subject to provide new social media account credentials for the first social media account to the social media monitoring system, and transmitting the new credentials for the first social media account from the social media monitoring system to the social media server for the online social media service to obtain access to the first social media account.

In some examples, the method further comprises a number of steps. Event data indicating a date of an event is received from a third user. An event report is generated comprising a pre-event section based on pre-event stored social media content of the subject from each of two or more of the plurality of social media accounts, wherein the pre-event stored social media relates to dates prior to the date of the event, and a post-event section based on post-event stored social media content of the subject from each of two or more of the plurality of social media accounts, wherein the post-event stored social media relates to dates after the date of the event.

In some examples, the social media content includes video content.

In some examples, the social media content includes image content.

In some examples, wherein the social media content includes text content.

In accordance with a second aspect of the present disclosure, there is provided a social media monitoring system, comprising a processor device, and a memory storing machine-readable instructions which, when executed by the processor device, cause the social media monitoring system to perform the method steps described above.

In accordance with a third aspect of the present disclosure, there is provided a non-transitory processor readable medium having tangibly stored thereon executable instructions that, when executed by a processor, cause the processor to perform the method steps described above.

### BRIEF DESCRIPTION OF THE DRAWINGS

FIG. 1 is a block diagram illustrating a cloud computing architecture suitable for delivering a social media monitoring service according to example embodiments described herein.

FIG. 2 is a block diagram of an example server device suitable for providing a social media monitoring service according to example embodiments described herein.

FIG. 3 is a block diagram of a social media monitoring service interacting with client devices and social media platforms according to example embodiments described herein.

FIG. 4 is a flowchart showing the steps of a method for monitoring social media accounts according to example embodiments described herein.

FIG. 5 is a flowchart showing the steps of a method for generating an event report based on stored social media content according to example embodiments described herein.

FIG. 6 is a flowchart showing the steps of a method for obtaining updated credentials for social media account access according to example embodiments described herein.

FIG. 7 is an example user interface screen of a social media monitoring service for adding a new subject according to example embodiments described herein.

FIG. 8 is an example user interface screen of a social media monitoring service for viewing the authentication status of subjects according to example embodiments described herein.

FIG. 9 is an example user interface screen of a social media monitoring service for viewing a subject profile according to example embodiments described herein.

FIG. 10 is an example user interface screen of a social media monitoring service for viewing a user dashboard according to example embodiments described herein.

FIG. 11 is an example user interface screen of a social media monitoring service for viewing escalated posts according to example embodiments described herein.

FIG. 12 is an example user interface screen of a social media monitoring service for defining and generating a new report according to example embodiments described herein.

FIG. 13 is an example user interface screen of a social media monitoring service for viewing an administrator user screen according to example embodiments described herein.

FIG. 14 is an example user interface screen of a social media monitoring service for reviewing and commenting on social media content according to example embodiments described herein.

FIG. 15 is an example user interface screen of a social media monitoring service for reviewing pre-event and post-event social media content according to example embodiments described herein.

FIG. 16 is an example user interface screen of a social media monitoring service for viewing un-reviewed social media content according to example embodiments described herein.

FIG. 17 is an example page of a report generated according to example embodiments described herein.

Similar reference numerals may have been used in different figures to denote similar components.

### DESCRIPTION OF EXAMPLE EMBODIMENTS

The present disclosure is made with reference to the accompanying drawings, in which embodiments are shown. However, many different embodiments may be used, and thus the description should not be construed as limited to the embodiments set forth herein. Rather, these embodiments are provided so that this disclosure will be thorough and complete. Wherever possible, the same reference numbers are used in the drawings and the following description to refer to the same elements, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although they are illustrated separately for ease of explanation herein. Different devices may have different designs, such that although some devices implement some functions in fixed function hardware, other devices may implement such functions in a programmable processor with code obtained from a machine-readable medium. Lastly, elements referred to in the singular may be plural and vice versa, except where indicated otherwise either explicitly or inherently by context.

The present disclosure provides example methods, systems, and processor readable media for ongoing monitoring, collection, storage, and processing of online content from a plurality of online social media accounts controlled by a single user. Example embodiments may be used to provide a social media monitoring service to investigatory organizations (such as law firms, investigation firms, and potential employers) and their clients or customers (such as potential clients of a law firm, or job applicants), referred to herein as “subjects”. In some contexts, a subject may have interests potentially adverse to those of the investigatory organization: for example, the subject may be an adverse party in litigation, who has agreed to grant access to his or her social media accounts as part of a discovery plan, or the subject may be a potential client or potential employee of the investigatory body who has agreed to grant access to his or her social media accounts in order to allow the investigatory organization to carry out a due diligence investigation. In other contexts, the subject's interests may be aligned with those of the investigatory organization, and access may be granted in order to facilitate the collection and management of evidence to be used by the organization to further the subject's interests, e.g., in a lawsuit involving the subject. It will be appreciated that the embodiments described herein may be used in other contexts as well.

In some embodiments, the social media monitoring service may be implemented on a cloud computing platform as a cloud computing service. In addition, one or more of the other components working with the social media monitoring service, such as the client and/or the online service(s), may operate on a cloud computing platform.

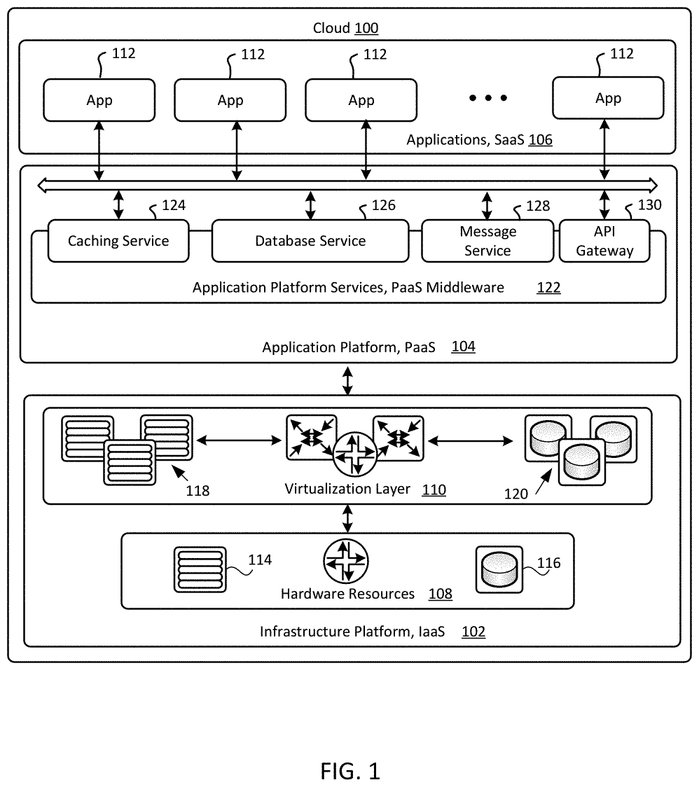

FIG. 1 is a logical block diagram schematically illustrating a cloud computing architecture that can deliver cloud computing services. The illustrated logical diagram of the cloud computing architecture 100 (referred to hereinafter as the cloud 100) generally comprises an infrastructure platform 102 (e.g. Infrastructure as a Service (IaaS) layer), an application platform 104 (e.g. Platform as a Service (PaaS) layer), and applications 106 (e.g., Software as a Service (SaaS) layer). The infrastructure platform 102 comprises the physical hardware resources 108, and a virtualization layer 110 that presents an abstraction of the physical hardware resources 108 to the application platform 104. The abstraction presented by the virtualization layer 110 depends on the requirements of the applications 112 being hosted on the application platform 104. The physical hardware resources 108 include physical machines 114 that include processing resources (e.g., central processing units (CPUs), graphic processing units (GPUs), accelerators, tensor processing units (TPUs)), physical storage 116 that include storage resources such as memory (e.g., static random access memory (SRAM), dynamic random access memory (DRAM), synchronous DRAM (SDRAM), read-only memory (ROM), persistent storage devices (e.g. hard disk drives, optical drives, or a combination thereof), and networking resources (not shown) that are generally resident within a data center. A data center, as will be understood in the art, includes a collection of the physical hardware resources 108 (typically in the form of servers) that can be used as a collective computing resource comprising processing, storage, and networking resources. Within a data center, a plurality of servers can be connected together to provide a computing resource pool upon which virtualized entities can be instantiated. Data centers can be interconnected with each other to form pools of computing resources connected to each by connectivity resources. The connectivity resources may take the form of physical connections such as Ethernet or optical communications link.

The virtualization layer 110 supports a flexible and efficient multi-tenancy run-time and hosting environment for applications 112 by providing Infrastructure as a Service (IaaS) facilities. The virtualization layer 110 includes a virtualization manager or hypervisor (not shown) that may provide a security and resource “sandbox” for each application 112 being hosted by the application platform 104. Each “sandbox” may be implemented as a Virtual Machine (VM) 118 that may include an appropriate operating system and controlled access to virtualized storage resources 120.

The virtualization of the physical hardware resources 108 by the virtualization layer 110 is considered to be foundational technology for the cloud 100. Virtualization of is a technology that allows for the creation of virtual computing resource pools of computing resources (e.g., processing, storage, and networking resources) connected to each by connectivity resources. Virtualization may take the form of instantiating VMs 118 that, to another entity on a network and to software executed on the VM 118, is no different than a physical computing device. A VM 118 has its own set of computing resources (e.g. processing, storage, and connectivity resources), upon which an operating system can be executed. The VM 118 can have a virtual network interface that can be assigned a network address. Between the underlying resources and the VM 118, there is typically a hypervisor (not shown) that manages the resource isolation and network interactions. One of the purposes of a VM 118 is to provide isolation from other processes running on the cloud 100. When initially developed, a VM 118 was a mechanism to allow different processes to operate without concern that a single errant process would be able to cause a complete system crash. Instead, an errant process would be contained to its own VM 118. This isolation allows for each VM 118 to have its own set of network interfaces. Typically, a single underlying computing resource can support a plurality of virtualized entities.

It will be appreciated by those skilled in the art that a more recent development has been the use of containers in place of VMs 118. As mentioned above, each VM 118 typically includes its own operating system which typically increases redundant computing, storage, and connectivity resource usage. Containers allow a single operating system (OS) kernel to support a number of isolated applications. In place of a hypervisor that allows each VM 118 to run its own OS, a single OS hosts containers that are responsible for enforcing the resource isolation that would otherwise be provided by the VM 118.

The application platform 104 provides the capabilities for hosting applications 112 and includes application platform services 122. The application platform services 122 provide a set of middleware application services and infrastructure services to the applications 112 hosted on the application platform 104. Applications 112 hosted on the application platform 104 may run on either the VMs or the physical machines. In the embodiment depicted in FIG. 1, the application platform services 122 include a cloud caching service system 124 for in-memory data storage, a database service 126 for applications, a message service 128 for publishing messages to subscriber customers, and an application program interface (API) gateway service that enables customers to create, publish, and maintain application program interfaces (APIs) to access other cloud services. It will be appreciated by those skilled in the art that the application platform services 112 may provide other middleware application services to customers, such as notification services, run-time services, and the like. Applications 112 from customers may be deployed and executed within a respective VM 118 or physical machine 114.

In some embodiments, the social media monitoring service may be implemented on a single device, such as a network server, instead of a cloud computing platform.

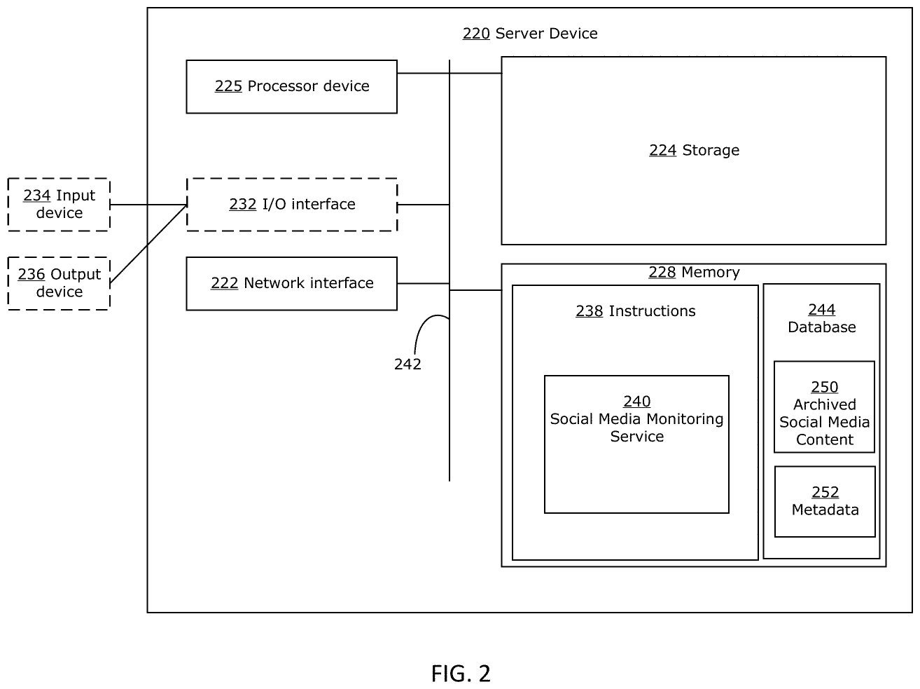

FIG. 2 is a block diagram illustrating a simplified example of a server device 220, such as a network server, suitable for carrying out examples described herein. Other examples suitable for implementing embodiments described in the present disclosure may be used, which may include components different from those discussed below. Although FIG. 2 shows a single instance of each component, there may be multiple instances of each component in the server device 220.

The server device 220 may include one or more processor devices 225, such as a processor, a microprocessor, a digital signal processor, an application-specific integrated circuit (ASIC), a field-programmable gate array (FPGA), a dedicated logic circuitry, a dedicated artificial intelligence processor unit, or combinations thereof. The server device 220 may also include one or more optional input/output (I/O) interfaces 232, which may enable interfacing with one or more optional input devices 234 and/or optional output devices 236.

In the example shown, the input device(s) 234 (e.g., a maintenance console, a keyboard, a mouse, a microphone, a touchscreen, and/or a keypad) and output device(s) 236 (e.g., a maintenance console, a display, a speaker and/or a printer) are shown as optional and external to the server device 220. In other examples, there may not be any input device(s) 234 and output device(s) 236, in which case the I/O interface(s) 232 may not be needed.

The server device 220 may include one or more network interfaces 222 for wired or wireless communication with one or more devices or systems of a network, such as network 210. The network interface(s) 222 may include wired links (e.g., Ethernet cable) and/or wireless links (e.g., one or more antennas) for intra-network and/or inter-network communications.

The server device 220 may also include one or more storage units 224, which may include a mass storage unit such as a solid state drive, a hard disk drive, a magnetic disk drive and/or an optical disk drive.

The server device 220 may include one or more memories 228, which may include a volatile or non-volatile memory (e.g., a flash memory, a random access memory (RAM), and/or a read-only memory (ROM)). The non-transitory memory(ies) 228 may store instructions for execution by the processor device(s) 225, such as to carry out examples described in the present disclosure. The memory(ies) 228 may include software instructions 238, such as for implementing an operating system and other applications/functions. In some examples, the memory(ies) 228 may include software instructions 238 for execution by the processor device 225 to implement a social media monitoring service 240, as described further below.

The memor(ies) 228 may also include a database 244 containing archived social media content 250 (also called “stored social media content”) and metadata 252 relating to the stored social media content 250, as described in detail below. The contents of the database 244 may be stored in the storage 224 and loaded into memory 228 when the social media monitoring service 240 is executed by the processor device 225.

In some examples, the server device 220 may additionally or alternatively execute instructions from an external memory (e.g., an external drive in wired or wireless communication with the server device 220) or may be provided executable instructions by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

The server device 220 may also include a bus 242 providing communication among components of the server device 220, including those components discussed above. The bus 242 may be any suitable bus architecture including, for example, a memory bus, a peripheral bus or a video bus.

It will be appreciated that various components and operations described herein can be implemented on multiple separate devices or systems in some embodiments.

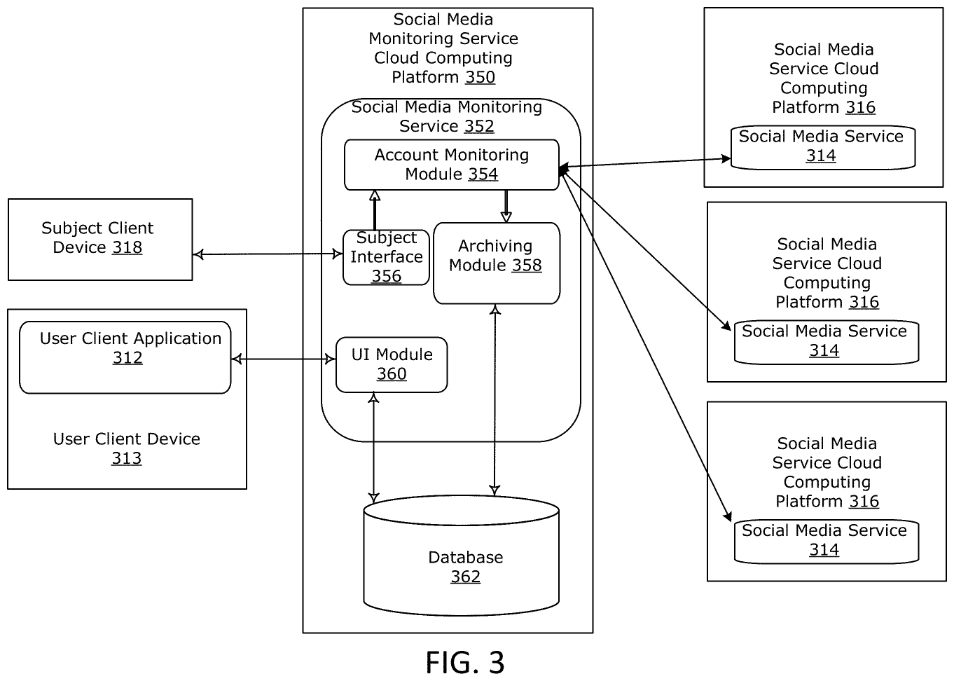

FIG. 3 shows a first example embodiment of a social media monitoring service 352. The social media monitoring service 352 is hosted on a social media monitoring service cloud computing platform 350. In some embodiments, the social media monitoring service 352 could be hosted using the cloud computing architecture 100 of FIG. 1, wherein the social media monitoring service 352 would be one of the applications 112, and the database 362 would be maintained by the database service 126. In other embodiments, the social media monitoring service 352 could be hosted on the server device 220 of FIG. 2, wherein the functionality of the social media monitoring service 352 would be provided by the social media monitoring service 240 stored in memory 228 when executed by the processor device 225, and the database 362 would be the database 250. It will be appreciated that other hardware, software, and network configurations for deploying the social media monitoring service 352 are possible and fall within the scope of the present disclosure.

The social media monitoring service 352 communicates with a subject client device 318 such as a personal computer operated by a subject (i.e., a social media user). The social media monitoring service 352 also communicates with a user client device 313, such as a personal computer operated by a user of the social media monitoring service 352 (i.e., a member of an investigatory organization monitoring the subject's social media accounts). The user client device 313 hosts a user client application 312, which is a software application running on the subject client device 318 that is used to access and interact with the social media monitoring service 352. The user client application 312 may be a web browser in some embodiments. In other embodiments, it may be a specialized software application specifically designed to interact with the social media monitoring service. In some embodiments, different types of users (as described in greater detail below) may use different user client applications 312

The social media monitoring service 352 is also in communication with one or more social media services 314 hosted on social media service cloud computing platforms 316. Each social media service 314 may have an application program interface (API) enabling interaction between the social media monitoring service 352 and the social media service 314. Example of social media services 314 that may be used by the social media monitoring service 352 include, but are not limited to, Facebook™, Instagram™, Twitter™, YouTube™, and TikTok™.

The social media monitoring service 352 is also in communication with a database 362. The database 362 may be any data storage means, hosted on one or more physical devices and/or cloud storage platforms. In the illustrated embodiment, the database 362 is hosted by the social media monitoring service cloud computing platform 350, but other embodiments may host the database 362 on other devices or platforms, such as the user client device 313. In some examples, each investigative organization may have its own database 362 located and maintained on a device or platform controlled by the investigative organization. This may present a further advantage, in some examples, of allocating the various risks and responsibilities between the investigative organization and the social media monitoring service such that the responsibility of maintaining the security and integrity of the stored social media content falls to the investigative organization, not the social media monitoring service 352. In such embodiments, the social media monitoring service 352 effectively acts as a conduit for retrieving and updating the subjects' social media content, liberating the investigative organization from the security and technical challenges associated with obtaining and using the subject's social media account credentials to retrieve the social media content, while passing all social media content through to the investigative organization once retrieved such that no second copy of the retrieved content exists anywhere but within the investigative organization.

The social media monitoring service 352 has access to the database 362 for storing, retrieving, and altering the data stored in the database. In the illustrated embodiment, the social media monitoring service 352 acts as an intermediary for client application 312 access to the database 362 via the user interface (UI) module 360, but in some embodiments the user client application 312 may have direct or alternative means of access to the database 362.

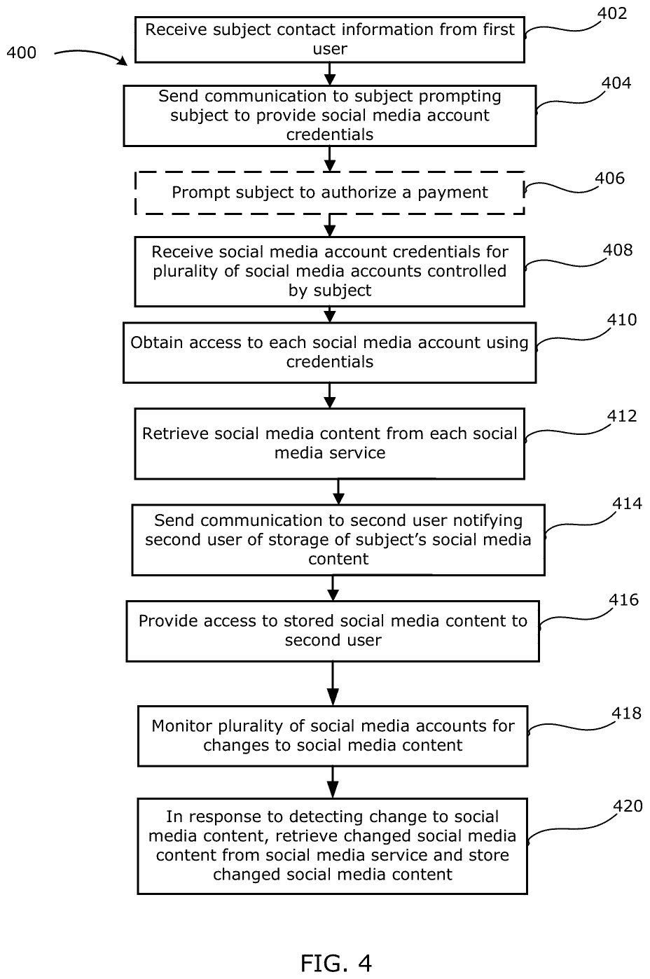

The social media monitoring service 352 includes several functional modules that carry out various steps of the methods described herein. A subject interface module 356 handles communication with the subject client device 318 for the purpose of communicating with the subject to obtain the subject's social media credentials and payment authorization as described below with reference to FIG. 4. A user interface (UI) module 360 handles communication with the user client application 312 of the user client device 313 for the purpose of communicating with the user to enable the user to view and manage the database 362 contents as described below with reference to FIG. 4. An account monitoring module 354 uses the social media account credentials obtained from the subject via the subject interface module 356 to access the various social media services 314, retrieves the subject's social media content from the social media services 314, and stores the retrieved social media content in the database 362 by invoking an archiving module 358. The archiving module 358 may perform certain steps to update the database and reconcile it with the social media accounts in an efficient way, for example by checking the time stamps on existing stored social media content in the database 362 and prompting the account monitoring module 354 to only retrieve social media content that is not already stored in the database with an up-to-date time stamp. It will be appreciated that various data reconciliation techniques, such as those used by remote backup software and “syncing” software, may be applied by the archiving module 358 and/or account monitoring module 354 to efficiently and reliably update the social media content stored in the database 362 to mirror the content stored in the subject's social media accounts with the social media services 314.

FIG. 4 illustrates an example method 400 for a subject's monitoring social media accounts using a social media monitoring service, such as social media monitoring service 352.

At step 402, the social media monitoring service 352 receives subject contact information from a first user. The first user may communicate using a user client application 312 running on a user client device 313 to communicate with the social media monitoring service 352 via the user interface module 360. In some embodiments, the first user is a member of the investigatory organization, such as a clerk, lawyer, or administrator responsible for client intake. The subject contact information may be obtained by the first user in the source of client intake, and may include a telephone number and/or email address where the subject can receive an electronic message containing instructions for interacting with the social media monitoring service 352 as described in the steps below.

In some embodiments, the first user may have limited permissions to access the social media monitoring service 352. For example, the first user may not be able to access (e.g. view or edit) any content of the database 362, or may only be able to create and/or revise subject profiles in the database containing non-social media content pertaining to a new subject (e.g. name and contact information).

At step 404, the social media monitoring service 352 uses the subject contact information to send a communication to the subject prompting the subject to provide the social media account credentials to the social media monitoring system. The communication may be, e.g., an email message or a text message (e.g., short message service (SMS) or iMessage™). The communication may contain instructions for interacting with the social media monitoring service 352, including a universal resource locator (URL) hyperlink to a web interface for interacting with the social media monitoring service 352 via the subject interface module 356.

At step 406, optionally (optional steps are shown in dashed lines), the communication prompts the subject to authorize a payment. The payment prompt may appear directly in the communication (e.g., email) itself, or it may appear to the subject when the subject follows the instructions or hyperlink in the communication to interact with the subject interface module 356 using the subject client device 318. In some embodiments, the subject uses a standard web browser running on the subject client device 318 to interact with the subject interface module 356, which includes a web server configured to interact with the subject's web browser. In some embodiments, the subject downloads, installs, and runs a specialized client software application (such as a mobile app) on the subject client device 318 to interact with the subject interface module 356, which includes a server software process for interacting with the subject client app.

The subject interface module 356 of the communication may direct the subject client device 318 to complete a payment processing procedure, either through the subject interface module 356, or via a third party payment processing service hosted on another server. The payment may be routed to the investigative organization or to the provider of the social media monitoring service 352. In either case, it may be used to pay for the cost of providing the social media monitoring service 352, and may be considered an administrative fee required before a subject can be taken on as a client or prospective employee of the investigative organization. By managing the payment portion of a subject intake process, the social media monitoring service 352 eliminates the need for the investigative organization to manage the liability risks and administrative overhead involved in processing payments from subjects who do not yet have a trusted relationship with the investigative organization.

In some embodiments, step 406 is omitted, and the investigative organization (or a member thereof, e.g., the first user) authorizes a payment to the social media monitoring service 352 during the process of supplying subject contact information at step 402 as part of a process for opening a new subject profile. The communication at step 404 is only sent to the subject after the payment from the investigative organization is confirmed.

At step 408, social media account credentials for a plurality of social media accounts controlled by the subject are received from the subject at the social media monitoring service 352. Each social media account corresponds to an online social media service 314. This step 408 may be performed in response to determining that the user has authorized the payment. The subject uses the subject client device 318 to interact with the subject interface module 356, which prompts the subject to identify which of several social media services 314 the user uses, then prompts the subject to enter his or her credentials (e.g., a username and password) for accessing each of those services 314. In some embodiments, the subject does not need to manually enter the credentials if he or she is using a subject client device 318 that is already logged into the services 314; instead, the subject may simply be prompted to authorize access to the social media service 314 by the social media monitoring service 352.

At step 410, for each social media account, the credentials for the social media account are transmitted from the social media monitoring service 352 to a respective social media service 314 running on a social media server for the online social media service 314 (e.g., social media service cloud computing platform 316) to obtain access to the social media account. This interaction between the social media monitoring service 352 and the social media service 314 is performed by the account monitoring module 354 and may be performed using an application programming interface (API) provided by the respective social media service 314. Thus, the account monitoring module 354 may include software code configured to call an API for each social media service 314 to access the subject's content stored in the social media service 314 in association with the subject's social media account.

In some embodiments, the social media credentials may be used to log in to the social media account using a web browser or other client application rather than directly invoking an API of the social media service 314. This may be necessary for social media services 314 that provide no API or limited API functionality.

At step 412, for each social media account, the account monitoring module 354 retrieves social media content from the social media service to the social media monitoring service 352. The account monitoring module 354 invokes the archiving module 358 to store the social media content, in association with a subject identifier identifying the subject (e.g., a universal identifier (UID) linked to a profile for the subject) in the database 362. The social media content may include, in various embodiments, textual data, image data, video data, and/or other types of data such as audio data. The retrieved content may also include associated metadata from the social media service 314, such as time stamps showing when the content was uploaded, as well as any associated tags, keywords, textual descriptions, titles, etc.

In embodiments accessing the social media service using a web browser or other client software, the social media content may be retrieved by storing the content delivered by the social media service to the web browser or other client application. It will be appreciated that techniques for mirroring, scraping, and/or crawling world wide web content may be used to retrieve social media content.

At step 414, after storing the content, the social media monitoring service 352 sends a communication to a second user notifying the second user of the storage of the subject's social media content. The communication may be, e.g., an email message, a text message, or an alert delivered via the UI module 360 to a second user accessing the social media monitoring service 352. The second user may be the first user or another member of the investigative organization, such as a clerk or junior lawyer tasked with performing initial review of the subject's social media content.

At step 416, the social media monitoring service 352 provides access to the stored social media content to the second user via the UI module 360. In some embodiments, the second user may have a set of permissions to access the social media monitoring service 352 that are more expansive than those of the first user. For example, the second user may have permission to view the stored social media content and associated metadata for some subset of the subjects whose content is stored in the database 362, and to add or revise certain metadata fields for those users. The role of the second user may therefore correspond to a user role tasked with performing the initial review of social media content for a subset of the investigative organization's subjects, and adding metadata pertaining to the results of said review, such as comments, tags, or notes associated in the database 362 with specific pieces of social media content for those subjects. In some examples, the roles of the first user and second user in the method 400 may be defined by roles or permissions set within the social media monitoring service 352, and the roles and permissions may be combined in a single user account or maintained in two separate user accounts.

At step 418, after storing the social media content, the account monitoring module 354 of the social media monitoring service 352 monitors the plurality of social media accounts for changes to the social media content.

In some embodiments, the account monitoring module 354 actively requests access to the social media account to determine whether any social media content has been changed. Such requests may be made at least once every 24 hours for each social media account of each subject being monitored. In some examples, some social media services 314 may pro-actively notify the account monitoring module of changed social media account content, for example via RSS, email, or another push-based messaging technique.

At step 420, in response to detecting a change to the social media content, the account monitoring module 354 retrieves changed social media content from the social media service 314 and storing the changed social media content in the database 362 using the archiving module 358. The changed social media content is stored by the archiving module 358 in association with the subject identifier and a time identifier, such as a time stamp. The time identifier may indicate the time and date at which the changed social media content was stored in the database 362, the time and date at which the changes social media content was changed or created on the social media service 314, or both. Changed social media content may mean contents of the social media account that have been added or modified since the last time they were accessed or retrieved. In some examples, content that has been deleted from the social media account may also be indicated in the database as changed social media content, for example by storing metadata in association with the stored content that has been deleted from the social media account, the metadata indicating a time and date at which the content was deleted from the social media account or when such deletion was detected.

In some embodiments, the social media monitoring service 352 may be configured to monitor a large number of social media accounts for a large number of subjects. For example, the social media monitoring service 352 may be provided to dozens or hundreds of investigative organizations, each of which may require that it monitor hundreds of subjects, each subject having one to five social media accounts. In such scenarios, it may be necessary to throttle or limit the number of simultaneous requests to retrieve content from a given social media service (also called “pull requests”) to avoid overloading the social media server or to avoid being blacklisted and having access to the social media accounts suspended. Various techniques may be used to throttle or limit the number of simultaneous requests. In some embodiments, the various requests may be scheduled over a 24-hour period such that stored content for each social media account is updated at least once every 24 hours. Thus, retrieving the changed social media content from the social media server may comprise scheduling said retrieval to keep a simultaneous number of retrieval requests to the social media server below a predetermined threshold, such as a simultaneous pull requests threshold.

After a subject's social media content has been retrieved and stored in the database 362, the social media monitoring service 352 may provide various functions to different types of users (e.g., members of the investigative organization). As described above, the second user may have limited permission to view the stored content for a subset of subjects, and to add metadata to the database associated with various pieces of such stored content. For example, the social media monitoring service 352 may provide, via the UI module 360, a commenting interface whereby the second user or another user may attach comments or tags to various pieces of stored social media content. This commenting interface may be used by the second user to perform an initial review and markup of the social media content for a subject, encompassing the subject's social media content from each of a plurality of social media services.

In addition to the first user and second user, additional user roles may be provided by the social media monitoring service 352. For example, a supervisor or senior attorney role may grant more comprehensive permissions in relation to the database contents relating to all subjects, or a larger subset of subjects, associated with the investigative organization. A supervisor user account may enable the supervisor to, e.g., view, modify and delete social media content and metadata associated with any subject associated with the supervisor's organization. The supervisor user account may also enable the user to define and generate reports based on the aggregated social media content and associated metadata for one or more subjects. A report definition interface may enable the parameters of a report to be defined, and a report viewing interface may enable the supervisor to dynamically generate and view defined reports for one or more subjects.

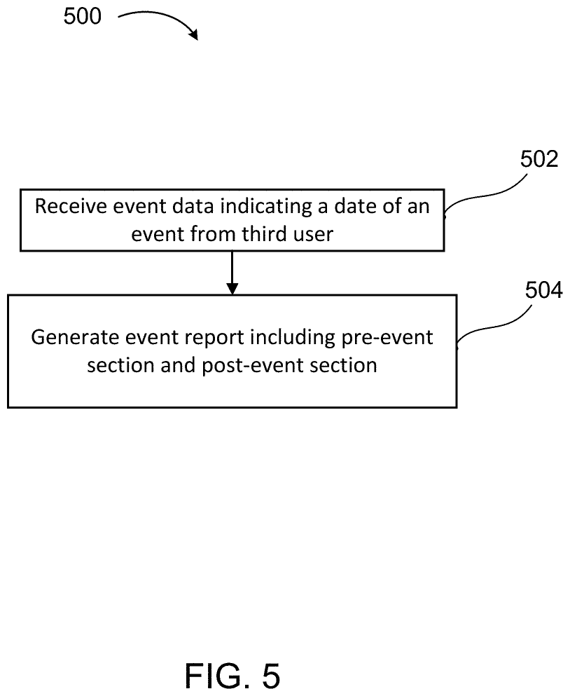

An example of a report type that the social media monitoring service 352 may be able to generate is an event report. A subject may have stored in the database 362, as part of the subject's profile, one or more key events that are relevant to the subject's file. For example, a personal injury law firm may monitor social media accounts for its clients (i.e. subjects), wherein each subject's profile defines a date of loss (e.g., date at which the client suffered an injury) as a key event. The social media monitoring service 352 may generate an event report using an event report generation method 500, as shown in FIG. 5, after at least steps 402 to 412 of method 400 have been performed for a subject.

FIG. 5 shows an example method 500 for generating an event report. At step 502, event data indicating a date of an event is received from a third user. The third user may be a clerk or administrator, such as the first user or second user, or it may be another user such as the supervisor. The responsibilities of the third user include defining the key event for the subject, e.g. defining the date of loss in a client file client during client intake. In some embodiments, the third user may enter the event data in a user interface screen of the social media monitoring service 352 via the UI module 360.

At step 504, an event report is generated by the UI module 360. The event report comprises a pre-event section and a post-event section. The pre-event section is based on pre-event stored social media content of the subject from each of two or more of the plurality of social media accounts. The pre-event stored social media relates to dates prior to the date of the event (e.g., the date of loss). The post-event section is based on post-event stored social media content of the subject from each of two or more of the plurality of social media accounts. The post-event stored social media relates to dates after the date of the event.

An event report may enable the investigative organization to quickly summarize relevant activities of the subject before and after a relevant event. Thus, for example, an event report may be defined to include social media content tagged with a specific keyword such as “athletics”. The report, when generated, would show all content from any of the monitored social media accounts of the subject that have been tagged with the keyword “athletics”, divided into pre-event and post-event content based on the time stamps of the content. This report would enable a supervisor (such as the senior attorney on a personal injury file) to review the subject's athletic activity as recorded across all social media platforms before and after an injury, allowing the supervisor to quickly identify possible strengths and weaknesses in the evidence.

It will be appreciated that keywords, tags, and other metadata stored in association with the social media content may come from any of a number of sources or processes. Some may be retrieved directly from the social media service in pre-existing association with a specific piece of content. Some may be added by a user, such as the second user (i.e. the reviewer), via the commenting interface. Some may be automatically generated, for example using a content classification algorithm such as a text or image classification algorithm trained using machine learning techniques. Reports and other data views provided by the social media monitoring service 352 may make use of any metadata stored in association with the content, as well as characteristics of the content itself, to categorize, recognize, or otherwise make decisions with regard to the stored social media content in situating said content within said reports or data views.

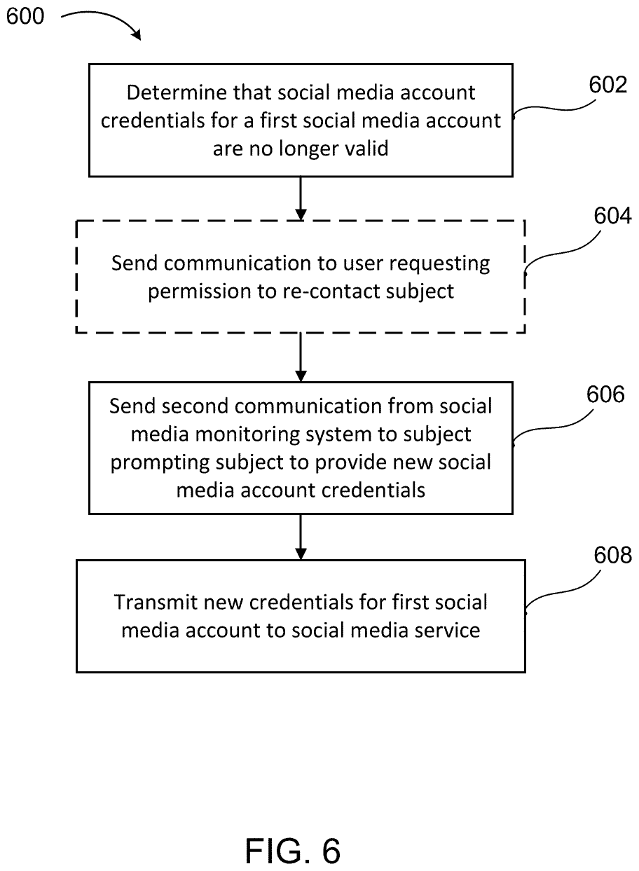

In some embodiments, the social media monitoring service 352 may be configured to automatically maintain valid account credentials for the social media services. In some cases, a subject's credentials may expire, or they may be invalidated through actions taken by the subject or the social media service 314. In such cases, the social media monitoring service 352 may take action to renew the credentials, as shown in method 600 of FIG. 6.

FIG. 6 shows an example method for obtaining updated credentials for social media account access. At 602, the account monitoring module 354 determines that the social media account credentials for a first social media account of the plurality of social media accounts controlled by a subject are no longer valid. This determination may be made in response to receiving an error message from the social media service 314 indicating that access has been denied in the course of attempting to access the social media service 314, e.g., at step 412 or 418 of method 400.

At 604, optionally, the social media monitoring service 352 sends a communication to a user (such as the first user, second user, or third user) at the investigative organization requesting permission to re-contact the subject to renew the credentials. This message may be, e.g., an email or text message containing a hyperlink that, when visited by a user client application 312, authorizes the social media monitoring service 352 to proceed with the remaining steps of the method 600.

At 606, the social media monitoring service 352 sends a second communication to the subject prompting the subject to provide new social media account credentials for the first social media account to the social media monitoring service 352. This second communication may be similar in form and function to the first communication to the subject at step 404 of method 400, although it may omit the step of requesting a payment. The new credentials are received from the subject as at step 408 of method 400.

At 608, the account monitoring module 354 transmits the new credentials for the first social media account to the social media service 314 to obtain access to the first social media account, as at step 410 of method 400.

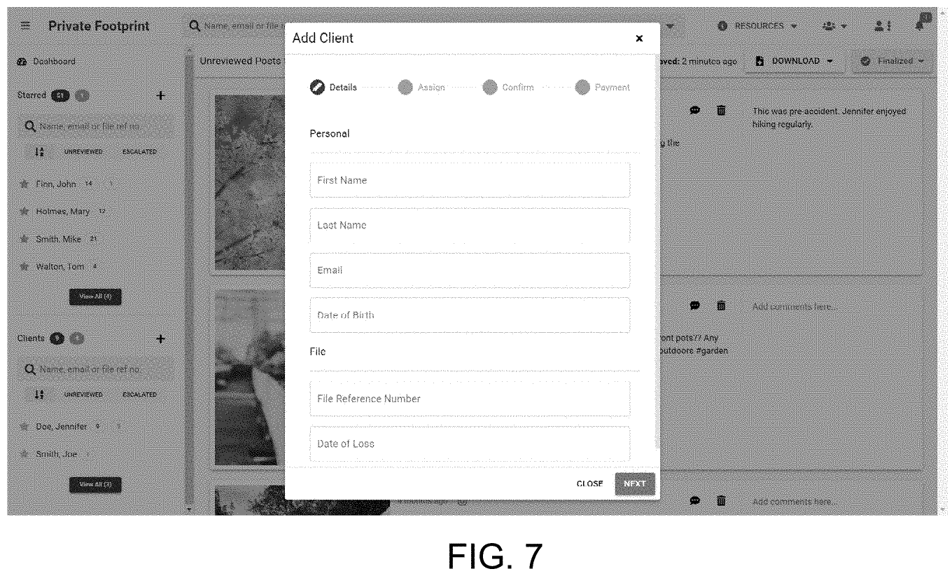

The UI module 360 may provide a number of different user interface screens displayed to a user via the user client application 312 on the user client device 313. The UI screens may enable the user to view and invoke different functions of the social media monitoring service 352. FIGS. 7-16 show examples of such UI screens, which are generated and sent to the user client device 313 by the UI module 360.

FIG. 7 is an example user interface screen of a social media monitoring service 352 for adding a new subject.

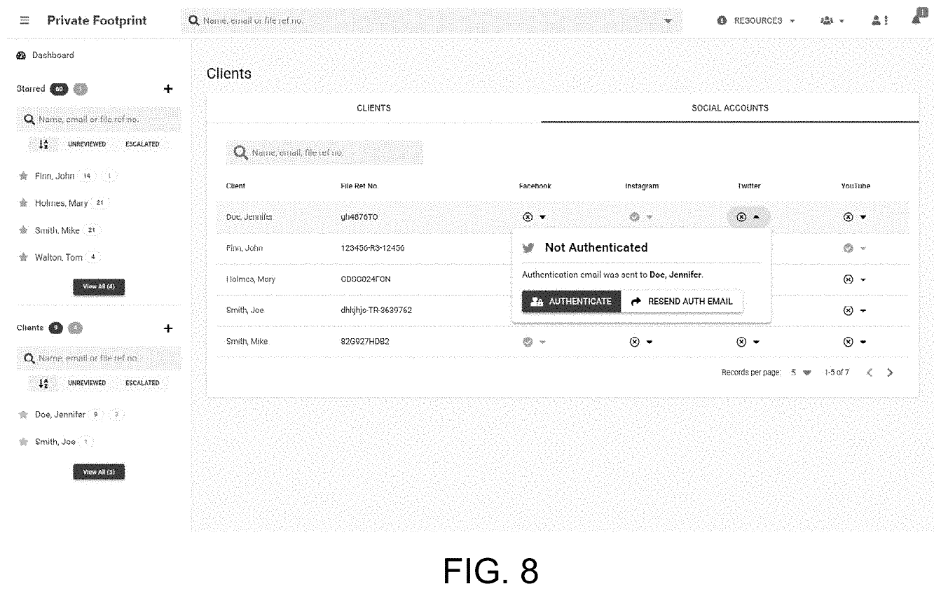

FIG. 8 is an example user interface screen of a social media monitoring service 352 for viewing the authentication status of subjects.

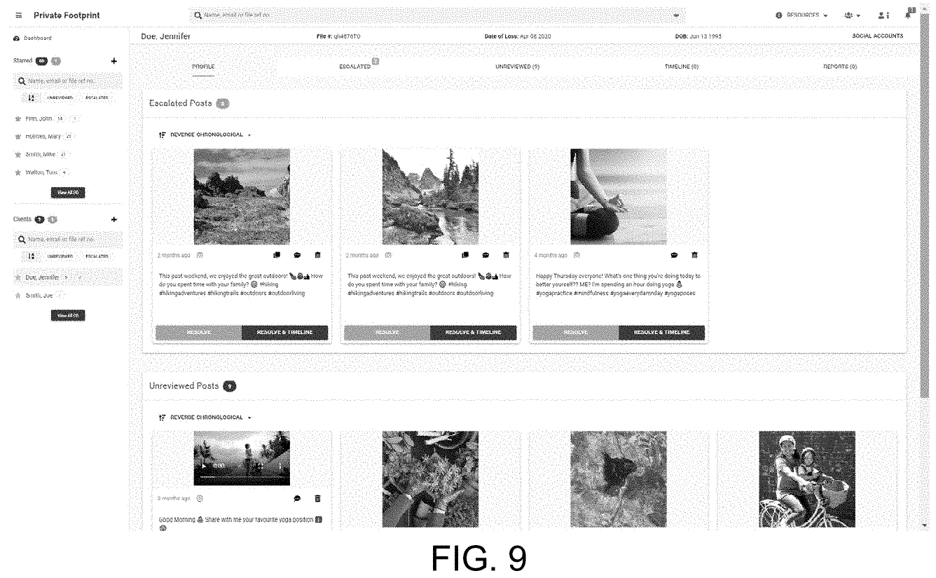

FIG. 9 is an example user interface screen of a social media monitoring service 352 for viewing a subject profile.

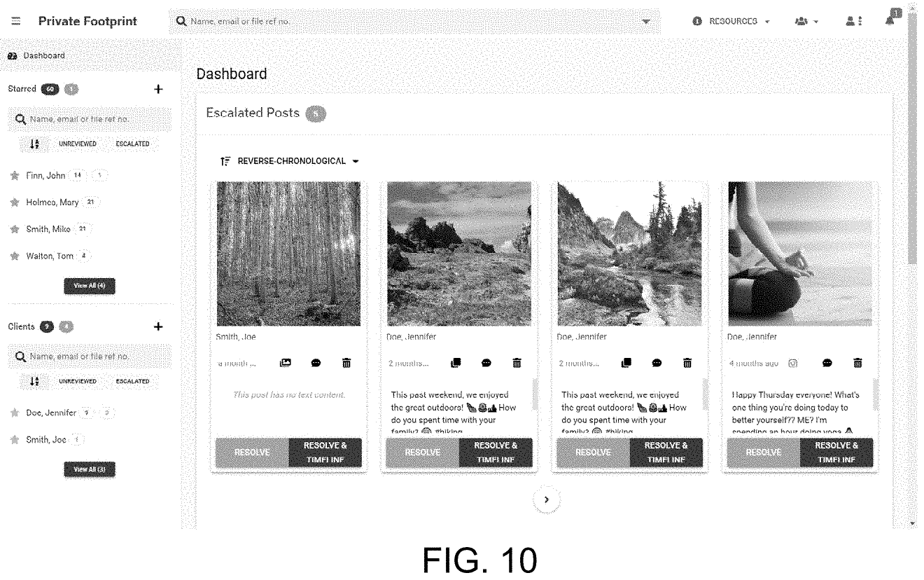

FIG. 10 is an example user interface screen of a social media monitoring service 352 for viewing a user dashboard.

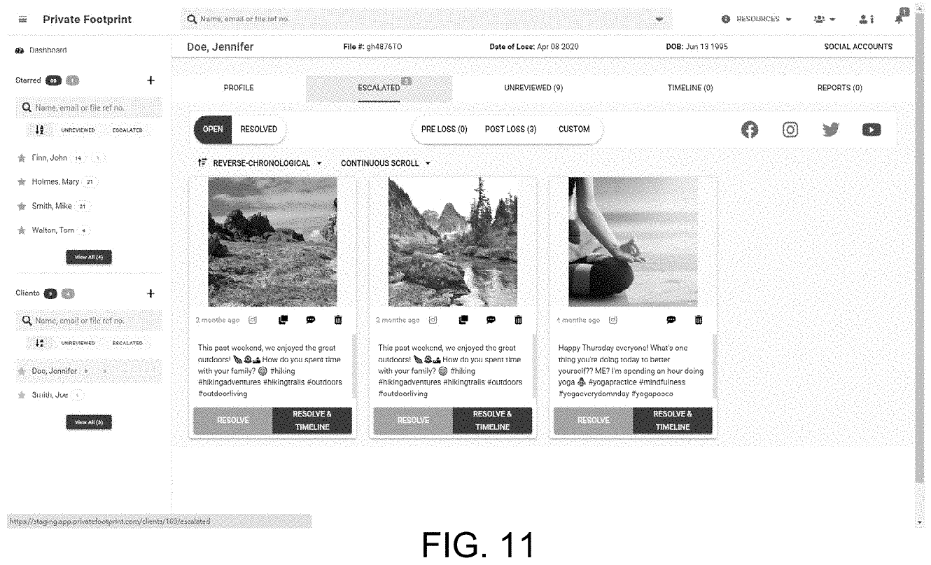

FIG. 11 is an example user interface screen of a social media monitoring service 352 for viewing escalated posts.

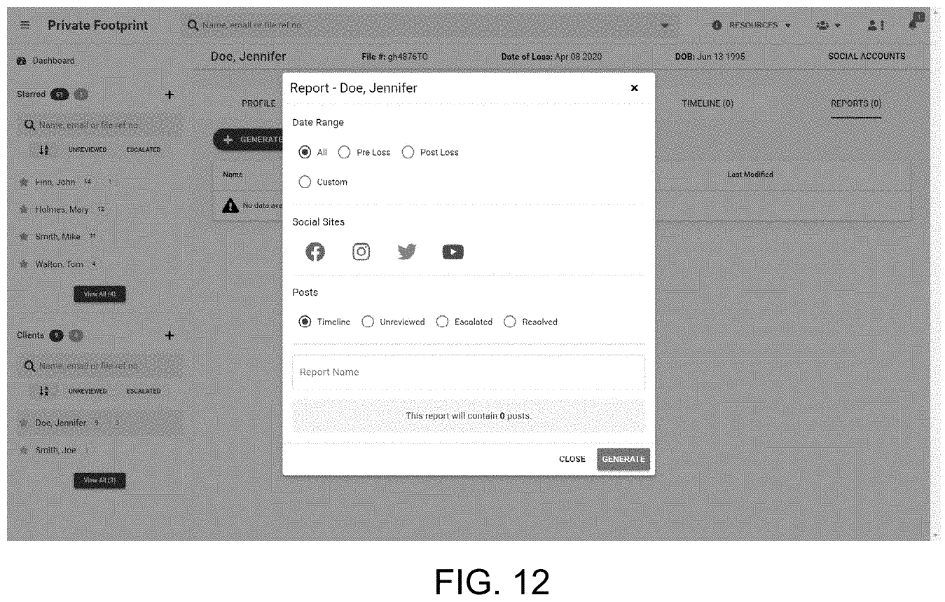

FIG. 12 is an example user interface screen of a social media monitoring service 352 for defining and generating a new report. In some embodiments, the reports are dynamically generated from the current database contents each time they are viewed. In other embodiments, the reports may be generated in response to specific user input and stored for repeated viewing.

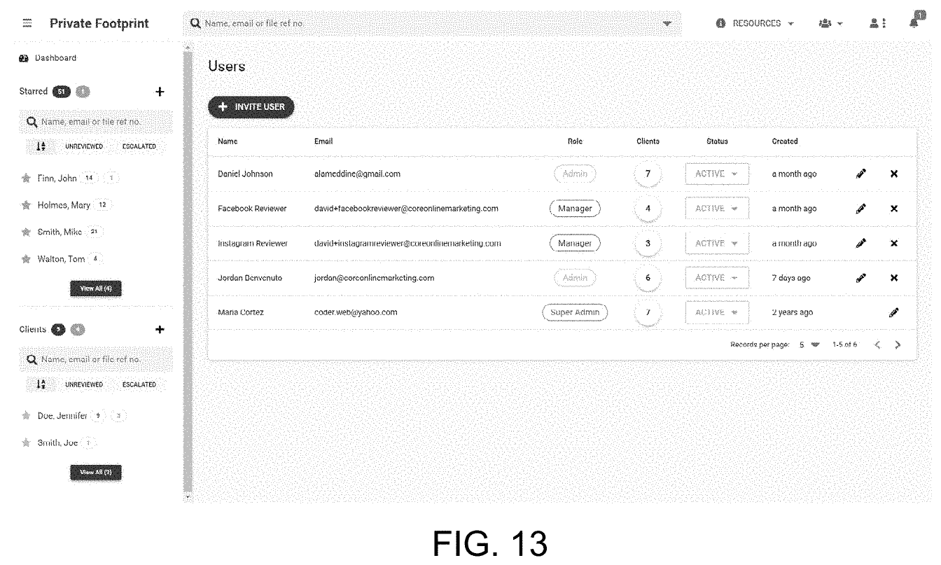

FIG. 13 is an example user interface screen of a social media monitoring service 352 for viewing an administrator user screen.

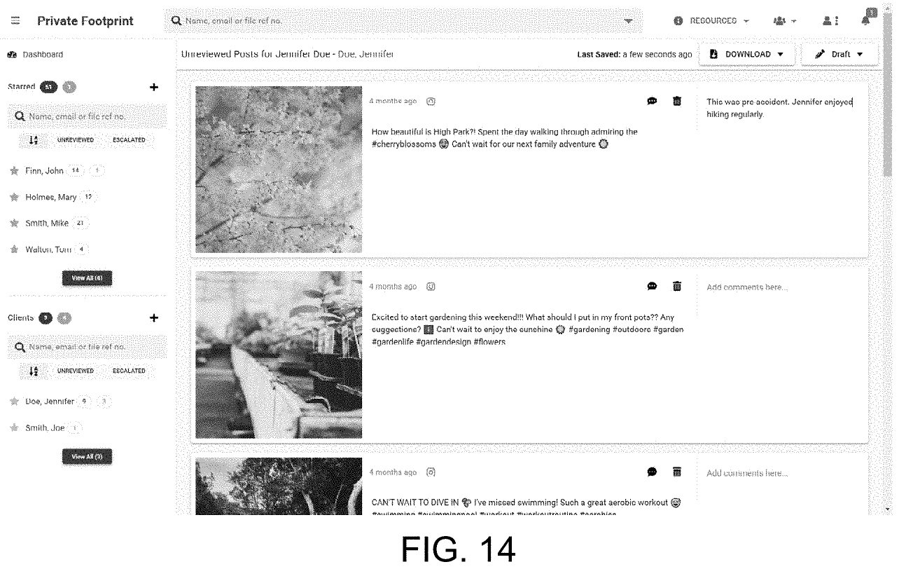

FIG. 14 is an example user interface screen of a social media monitoring service 352 for reviewing and commenting on social media content.

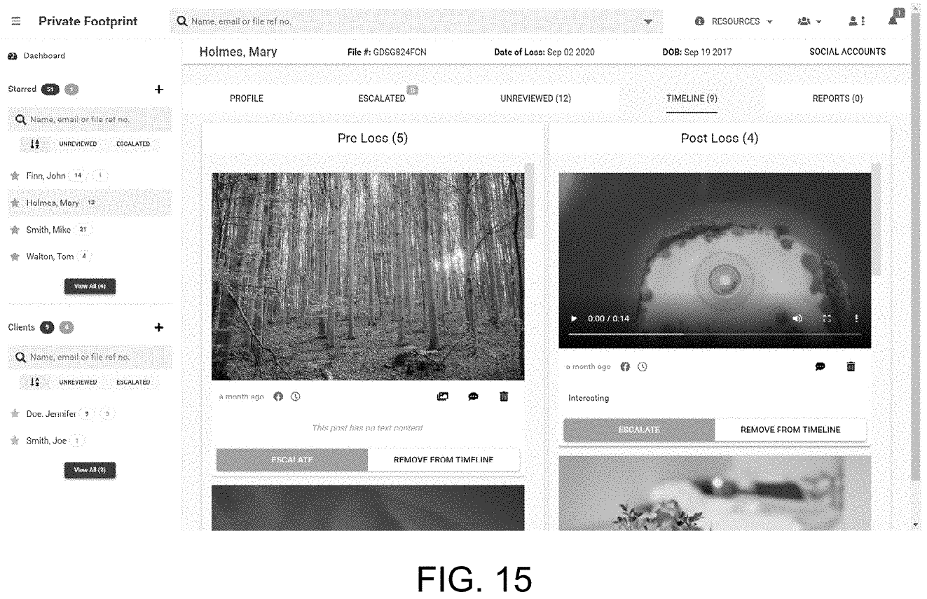

FIG. 15 is an example user interface screen of a social media monitoring service 352 for reviewing pre-event and post-event social media content.

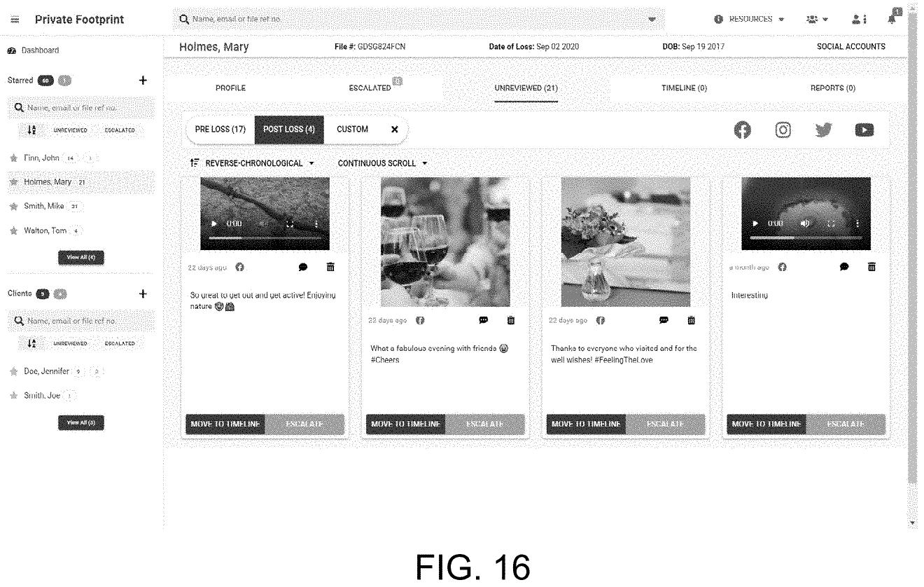

FIG. 16 is an example user interface screen of a social media monitoring service 352 for viewing un-reviewed social media content.

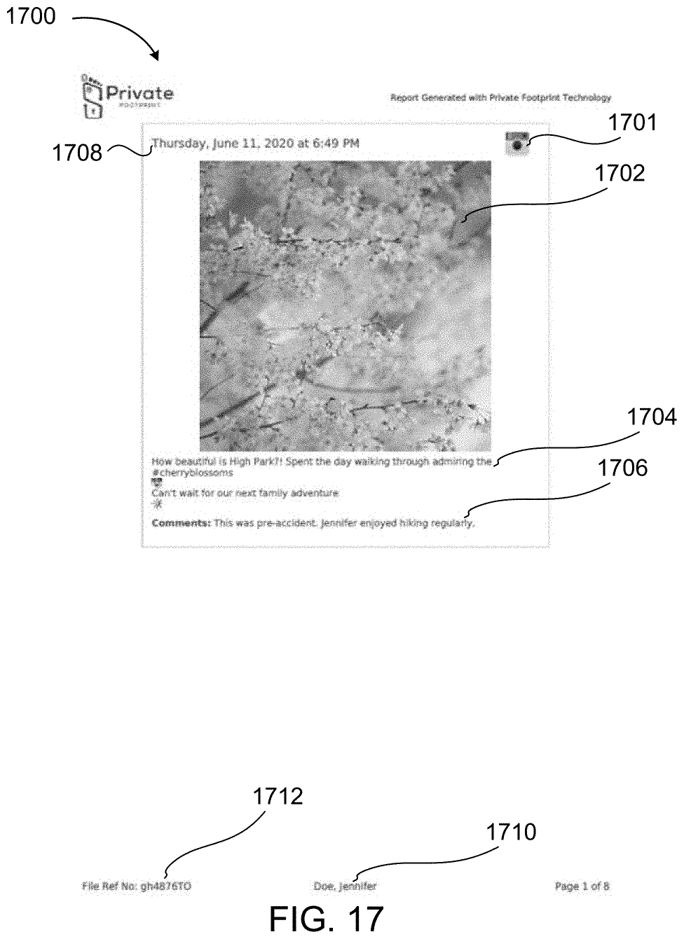

FIG. 17 shows an example page 1700 from a report that may be generated using the social media monitoring service 352, such as by generating a report at the UI screen of FIG. 12. The report page 1700 shows archived social media content 250 and metadata 252 relating to the stored social media content 250. The social media content 250 includes a photograph 1702 and caption 1704 archived from the subject's social media account. The metadata 252 includes an icon 1701 indicating the social media service from which the social media content 250 was retrieved, a date 1708 indicating the date when the social media content 250 was posted to the social media service, a comment or note 1706 generated by a user of the social media monitoring service 352 (e.g. a member of the investigatory organization), the name 1710 of the subject, and a file reference number 1712 identifying the subject's file or matter. It will be appreciated that a report generated using the social media monitoring service 352 may contain multiple pages, each having data and metadata that may include one or more of the fields shown in the example page 1700 and/or other types of data or metadata.

The user client device 313 and subject client device 318 are described as computers in communication with the social media monitoring service via a communication network. In some embodiments, the user client device 313 and/or subject client device 318 may be personal computers, smart phones or other mobile electronic devices, servers, or applications hosted on a cloud computing platform. In some embodiments, the user client device 313 and/or subject client device 318 may be hosted on the same computing platform as the social media monitoring service, such as the social media monitoring service cloud computing platform 350.

Communication between the social media monitoring service 352, the user client application 312, the subject client device 318, and/or the social media services 314 may vary between different embodiments. Such communication may be via a communication bus where one or more of the communicating components is implemented on the same physical computer as the component it communicates with. The communication may occur by a communication link, such as a wired or wireless digital communication link, and may take place via one or more intermediaries and/or via a communication network such as the Internet.

The steps and/or operations in the flowcharts and drawings described herein are for purposes of example only. There may be many variations to these steps and/or operations without departing from the teachings of the present disclosure. For instance, the steps may be performed in a differing order, or steps may be added, deleted, or modified.

The coding of software for carrying out the above-described methods described is within the scope of a person of ordinary skill in the art having regard to the present disclosure. Machine-readable code executable by one or more processors of one or more respective devices to perform the above-described method may be stored in a machine-readable medium such as the memory of the data manager. The terms “software” and “firmware” are interchangeable within the present disclosure and comprise any computer program stored in memory for execution by a processor, comprising Random Access Memory (RAM) memory, Read Only Memory (ROM) memory, EPROM memory, electrically EPROM (EEPROM) memory, and non-volatile RAM (NVRAM) memory. The above memory types are examples only, and are thus not limiting as to the types of memory usable for storage of a computer program.

All values and sub-ranges within disclosed ranges are also disclosed. Also, although the systems, devices and processes disclosed and shown herein may comprise a specific plurality of elements, the systems, devices and assemblies may be modified to comprise additional or fewer of such elements. Although several example embodiments are described herein, modifications, adaptations, and other implementations are possible. For example, substitutions, additions, or modifications may be made to the elements illustrated in the drawings, and the example methods described herein may be modified by substituting, reordering, or adding steps to the disclosed methods. In addition, numerous specific details are set forth to provide a thorough understanding of the example embodiments described herein. It will, however, be understood by those of ordinary skill in the art that the example embodiments described herein may be practiced without these specific details. Furthermore, well-known methods, procedures, and elements have not been described in detail so as not to obscure the example embodiments described herein. The subject matter described herein intends to cover and embrace all suitable changes in technology.

Although the present disclosure is described at least in part in terms of methods, a person of ordinary skill in the art will understand that the present disclosure is also directed to the various elements for performing at least some of the aspects and features of the described methods, be it by way of hardware, software or a combination thereof. Accordingly, the technical solution of the present disclosure may be embodied in a non-volatile or non-transitory machine-readable medium (e.g., optical disk, flash memory, etc.) having stored thereon executable instructions tangibly stored thereon that enable a processing device to execute examples of the methods disclosed herein.

The term “processor” may comprise any programmable system comprising systems using microprocessors/controllers or nanoprocessors/controllers, digital signal processors (DSPs), application specific integrated circuits (ASICs), field-programmable gate arrays (FPGAs) reduced instruction set circuits (RISCs), logic circuits, and any other circuit or processor capable of executing the functions described herein. The term “database” may refer to either a body of data, a relational database management system (RDBMS), or to both. As used herein, a database may comprise any collection of data comprising hierarchical databases, relational databases, flat file databases, object-relational databases, object oriented databases, and any other structured collection of records or data that is stored in a computer system. The above examples are example only, and thus are not intended to limit in any way the definition and/or meaning of the terms “processor” or “database”.

The present disclosure may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1. A method for monitoring online social media content, comprising the steps of:
receiving, at a social media monitoring system, social media account credentials for a plurality of social media accounts controlled by a subject, each social media account corresponding to an online social media service;
for each social media account:
transmitting the credentials for the social media account from the social media monitoring system to a social media server for the online social media service to obtain access to the social media account;
retrieving social media content from the social media server to the social media monitoring system; and
storing, at the social media monitoring system, the social media content in association with a subject identifier.

2. The method of claim 1, further comprising:
receiving, at the social media monitoring system, subject contact information from a first user; and
using the subject contact information to send a communication from the social media monitoring system to the subject prompting the subject to provide the social media account credentials to the social media monitoring system,
wherein the social media account credentials are received from the subject.

3. The method of claim 2, wherein:
the communication further prompts the subject to authorize a payment; and
the subject is prompted to provide the social media account credentials in response to determining that the user has authorized the payment.

4. The method of claim 3, further comprising, after storing the content, sending a communication to a second user notifying the second user of the storage of the subject's social media content.

5. The method of claim 4, further comprising providing access to the stored social media content to the second user.

6. The method of claim 1, further comprising, after storing the social media content:
monitoring the plurality of social media accounts for changes to the social media content; and
in response to detecting a change to the social media content:
retrieving changed social media content from the social media server; and
storing the changed social media content in association with the subject identifier and a time identifier.

7. The method of claim 6, wherein retrieving changed social media content from the social media server comprises scheduling said retrieval to keep a simultaneous number of retrieval requests to the social media server below a predetermined threshold.

8. The method of claim 6, further comprising:
determining that the social media account credentials for a first social media account of the social media accounts are no longer valid;
sending a second communication from the social media monitoring system to the subject prompting the subject to provide new social media account credentials for the first social media account to the social media monitoring system; and
transmitting the new credentials for the first social media account from the social media monitoring system to the social media server for the online social media service to obtain access to the first social media account.

9. The method of claim 1, further comprising:
receiving, from a third user, event data indicating a date of an event;
generating an event report comprising:
a pre-event section based on pre-event stored social media content of the subject from each of two or more of the plurality of social media accounts, wherein the pre-event stored social media relates to dates prior to the date of the event; and
a post-event section based on post-event stored social media content of the subject from each of two or more of the plurality of social media accounts, wherein the post-event stored social media relates to dates after the date of the event.

10. The method of claim 1, wherein the social media content includes video content.

11. The method of claim 1, wherein the social media content includes image content.

12. The method of claim 1, wherein the social media content includes text content.

13. A social media monitoring system, comprising:
a processor device; and
a memory storing machine-readable instructions which, when executed by the processor device, cause the social media monitoring system to perform the method of claim 1.

14. A non-transitory processor readable medium having tangibly stored thereon executable instructions that, when executed by a processor, cause the processor to perform the method of claim 1.
